(19) United States
(12) Patent Application Publication
(10) Pub. No.: US 2018/0188872 A1
(43) Pub. Date: Jul. 5, 2018

(54) PRESSURE SENSOR, HAPTIC FEEDBACK DEVICE AND RELATED DEVICES

(71) Applicant: BOE TECHNOLOGY GROUP CO., LTD., Beijing (CN)

(72) Inventor: Lin ZHU, Beijing (CN)

(21) Appl. No.: 15/528,665

(22) PCT Filed: Nov. 2, 2016
(86) PCT No.: PCT/CN2016/104357

§ 371 Date: May 22, 2017

(30) Foreign Application Priority Data
Mar. 30, 2016 (CN) 201610195373.8

(51) Int. Cl. G06F 3/041; G06F 3/044

(52) U.S. Cl. CPC G06F 3/0414; G06F 2203/04103; G06F 3/044

(57) ABSTRACT

The present disclosure provides a pressure sensor. The pressure sensor includes a first substrate, a second substrate, a sealant frame for bonding the edges of the first substrate and the second substrate and supporting the separation between the first substrate and the second substrate inside the sealant frame, a common electrode on the side of the first substrate, a plurality of independent pressure sensing electrodes on the side of the second substrate, and a pressure sensing circuit supplying pressure sensing signal to the common electrode and determining a position where an external force is applied by measuring at least one voltage on the pressure sensing electrodes. Only when an external force applied to at least one of the first substrate and the second substrate exceeds a certain threshold, the pressure sensing electrode corresponding to the position where the external force is applied contacts the common electrode.

### CROSS-REFERENCES TO RELATED APPLICATIONS

This application claims the priority of Chinese Patent Application No. 201610195373.8, filed on Mar. 30, 2016, the entire contents of which are incorporated herein by reference.

### FIELD OF THE DISCLOSURE

The present disclosure generally relates to the pressure sensing technology and, more particularly, relates to a pressure sensor, a haptic feedback device, and related devices.

### BACKGROUND

Pressure sensing technology is a technology for measuring strains due to external forces over an area. Pressure sensors are widely used in industrial control systems, medical devices, etc. There are many types of pressure sensors, such as, resistive strain sensors, semiconductor strain sensors, piezo-resistive pressure sensors, inductive pressure sensors, capacitive pressure sensors, resonant pressure sensors, and capacitive accelerometer pressure sensors.

However, the existing pressure sensors have complex structures. The disclosed pressure sensor, haptic feedback device and related devices are directed to at least partially solve one or more problems in this area.

### BRIEF SUMMARY OF THE DISCLOSURE

Directed to solve one or more problems set forth above and other problems in the art, the present disclosure provides an array substrate, a fabrication method, a display panel and a display device.

One aspect of the disclosure subject matter includes a pressure sensor. The pressure sensor includes: a first substrate; a second substrate facing toward the first substrate; a sealant frame for bonding the edges of the first substrate and the second substrate and for supporting a separation between the first substrate and the second substrate inside the sealant frame; a common electrode on one side of the first substrate inside the sealant frame and facing toward the second substrate; a plurality of pressure sensing electrodes on one side of the second substrate inside the sealant frame and facing toward the first substrate, wherein the plurality of pressure sensing electrodes are independent from each other, and when an external force applied to a position on at least one of the first substrate and the second substrate exceeds a certain threshold, at least one pressure sensing electrode corresponding to the position contacts the common electrode; and a pressure sensing circuit supplying pressure sensing signals to the common electrode, and determining a position where an external force is applied by measuring voltages on the pressure sensing electrodes.

In some embodiments, an area of an orthogonal projection of each pressure sensing electrode on a plane parallel to the second substrate inversely correlates with a distance between the plane and the second substrate.

In some embodiments, each pressure sensing electrode has a cone-shaped structure, a pyramid-shaped structure, or a frustum-shaped structure.

In some embodiments, the pressure sensing electrodes are made of carbon nanotubes.

In some embodiments, each pressure sensing electrode includes a first electrode on one side of the second substrate facing toward the first substrate, and a second electrode on one side of the first electrode facing toward the first substrate; an orthogonal projection of the first electrode on the second substrate covers entirely an orthogonal projection of the second electrode on the second substrate; and an area of an orthogonal projection of each second electrode on a plane parallel to the second substrate inversely correlates with a distance between the plane and the second substrate.

In some embodiments, each second electrode is a cone-shaped structure, a pyramid-shaped structures, or a frustum-shaped structure.

In some embodiments, the second electrodes are made of carbon nanotubes.

In some embodiments, the common electrode includes a third electrode on one side of the first substrate facing toward the second substrate, and a plurality of fourth electrodes on one side of the third electrode facing toward the second substrate; the third electrode has a plate-shaped structure; and an area of a orthogonal projection of each fourth electrode on a place parallel with the first substrate inversely correlates with a distance between the plane and the first substrate.

In some embodiments, each fourth electrode has a cone-shaped structure, a pyramid-shaped structure, or a frustum-shaped structure.

In some embodiments, the fourth electrodes are made of carbon nanotubes.

In some embodiments, at least one of the first substrate and the second substrate is a flexible substrate.

Another aspect of the disclosure subject matter includes a haptic feedback device, comprising: a haptic feedback circuit either on one side of the first substrate facing away from the second substrate, or on one side of the second substrate facing away from the first substrate; and a disclosed pressure sensor according used for determining at least one touch position, and for sending touch position information to a terminal; wherein the haptic feedback circuit produces voltage pulses based on instructions from the terminal.

Another aspect of the disclosure subject matter includes a glove used for a virtual reality system, wherein: at least a palm side of the glove includes a disclosed haptic feedback device; the first substrate and the second substrate of the pressure sensor in the haptic feedback device are flexible substrates; and the haptic feedback circuit is a flexible circuit, and is on an inner side of the glove.

Another aspect of the disclosure subject matter includes a helmet used for a virtual reality system, comprising: a disclosed haptic feedback device on an inner side of the helmet; wherein the first substrate and the second substrate of the pressure sensor in the haptic feedback device are flexible substrates, and the haptic feedback circuit is a flexible circuit.

Another aspect of the disclosure subject matter includes a virtual reality system, comprising: a terminal; and a disclosed glove, or a disclosed helmet.

Another aspect of the disclosure subject matter includes a method for fabricating a pressure sensor, comprising: providing a first substrate and forming a common electrode on the first substrate; providing a second substrate and forming a plurality of first electrodes on the second substrate; forming a plurality of second electrodes on the first electrodes; forming a sealant frame on the second substrate; and bonding the first substrate and the second substrate together by the sealant frame and curing the sealant frame with an ultra violet light.

In some embodiments, the plurality of first electrodes and the plurality of second electrodes are made of a same material; and the plurality of first electrodes and the plurality of second electrodes are formed in a single patterning process.

In some embodiments, the plurality of first electrodes and the plurality of second electrodes are made of carbon nanotubes; and the plurality of first electrodes and the plurality of second electrodes are formed by an ink-jet printing process, or by a surface growing process.

In some embodiments, each second electrode is a cone-shaped structure, a pyramid-shaped structure, or a frustum-shaped structure.

In some embodiments, forming the common electrode comprises: forming a third electrode on one side of the first substrate facing toward the second substrate, wherein the third electrode has a plate-shaped structure; and forming a plurality of fourth electrodes on one side of the third electrode facing toward the second substrate; wherein each fourth electrode is a cone-shaped structure, a pyramid-shaped structure, or a frustum-shaped structure.

Other aspects of the disclosed subject matter can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic diagram of an exemplary pressure sensor according to the disclosed embodiments;

FIGS. 2a-2b illustrate schematic diagrams of another exemplary pressure sensor according to the disclosed embodiments;

FIGS. 3a-3b illustrate schematic diagrams of another exemplary pressure sensor according to the disclosed embodiments;

FIG. 4 illustrates a schematic diagram of another exemplary pressure sensor according to the disclosed embodiments;

FIGS. 5a-5b illustrate schematic diagrams of another exemplary pressure sensor according to the disclosed embodiments;

FIGS. 6a-6d illustrate certain fabrication steps for manufacturing an exemplary pressure sensor according to the disclosed embodiments;

FIG. 7 illustrates a schematic diagram of an exemplary haptic feedback device according to the disclosed embodiments;

FIG. 8 illustrates a schematic diagram of an exemplary glove according to the disclosed embodiments; and

FIG. 9 illustrates a flow chart of an exemplary method for fabricating a pressure sensor according to the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts. Shapes and sizes in the drawings do not reflect the true proportions of the components. It should be understood that the exemplary embodiments described herein are only intended to illustrate and explain the present invention and not to limit the present invention. Other applications, advantages, alternations, modifications, or equivalents to the disclosed embodiments are obvious to those skilled in the art and are intended to be encompassed within the scope of the present disclosure.

The disclosed subject matter is mainly directed to a tactile feedback system. An outer layer of the tactile feedback system includes a pressure sensor that can sense pressures and stresses. The pressure sensor can be made of a plastic material and carbon nanotubes. An inner layer of the tactile feedback system includes a flexible electronic circuit formed by inkjet printing of an inkjet printer. The flexible electronic circuit can convert a pressure signal into an electrical signal. The electrical signal can transfer to the brain of a user of the tactile feedback system.

During the human-computer interaction, a user's body motion signals can be fed back to the processor. For example, when the user's hand clenches a first or makes another action, the carbon nanotube matrix can touch the flexible circuit board, resulting in different electrical outputs, which can be send back to the processer. As such, corresponding human action outputs can be transmitted to a virtual reality equipment to achieve a human-computer interactive experience.

When the virtual reality equipment sends an action signal (e.g., an explosion signal, a being touched signal, a force feedback signal, etc.) back to the user, a circuit board close to the user's body, such as a glove, can generate a voltage pulse to stimulate the user's skin to realize the human-computer interaction.

As one specific application example, multiple pressure sensors can be installed in a pair of gloves for detecting different gestures of a user's hands.

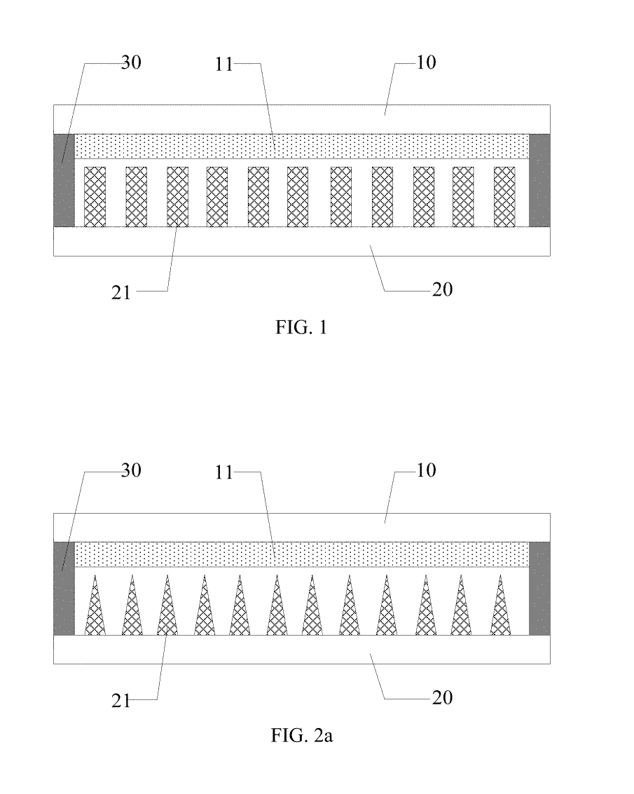

One aspect of the disclosed subject provides a pressure sensor. Referring to FIG. 1, a schematic view of an exemplary pressure sensor is illustrated in accordance with some embodiments.

As shown in FIG. 1, the pressure sensor may include a first substrate 10, a second substrate 20 configured facing toward the first substrate 10, a sealant frame 30 for bonding the first substrate 10 and the second substrate 20 together at the edges and for supporting the separation of the first substrate and the second substrate inside the sealant frame, a common electrode 11 disposed on one side of the first substrate 10 facing toward the second substrate 20, a plurality of independent pressure sensing electrodes 21 disposed on one side of the second substrate 20 facing toward the first substrate 10, and a pressure sensing circuit (not shown in the figure) configured to supply pressure sensing signals to the common electrode 11 and determine pressure point positions by measuring voltages received from the pressure sensing electrodes 21.

When an external force applied to one of the first substrate 10 and the second substrate 20 exceeds a pre-determined threshold, the pressure sensing electrodes 21 located at the position where an external force is applied may contact the common electrode 11.

The disclosed pressure sensor may include a first substrate, a second substrate, a sealant frame, a common electrode, a plurality of pressure sensing electrodes, and a pressure sensing circuit. The sealant frame may bond the edges of the first substrate and second substrate together and support the separation of the first substrate and the second substrate inside the sealant frame to ensure the insulation between the pressure sensing electrodes and the common electrode when no external force is applied. The sensing electrodes and the common electrode may contact with one another only when external forces are applied to the first substrate and/or the second substrate. Voltages may be detected from any pressure sensing electrode only when external forces are applied to the first substrate and/or the second substrate. The pressure sensing circuit may determine a position where an external force is applied by measuring at least one voltage received from the pressure sensing electrodes. Thus, a pressure sensor having a simple structure may be implemented.

In some embodiments, the pressure sensor can include multiple testing blocks. Each testing block can include at least one sensing electrode and a common electrode, such that each testing block can independently detect voltage signal and analyze pressure and movement when an external force is applied on a single testing block.

The disclosed pressure sensor may be described and illustrated in more details by the various specific embodiments below.

In one embodiment of an exemplary pressure sensor, as shown in FIG. 1, each pressure sensing electrode 21 may have a columnar structure. When an external force is applied to the first substrate 10 and/or the second substrate 20, certain pressure sensing electrodes 21 may contact the common electrode 11.

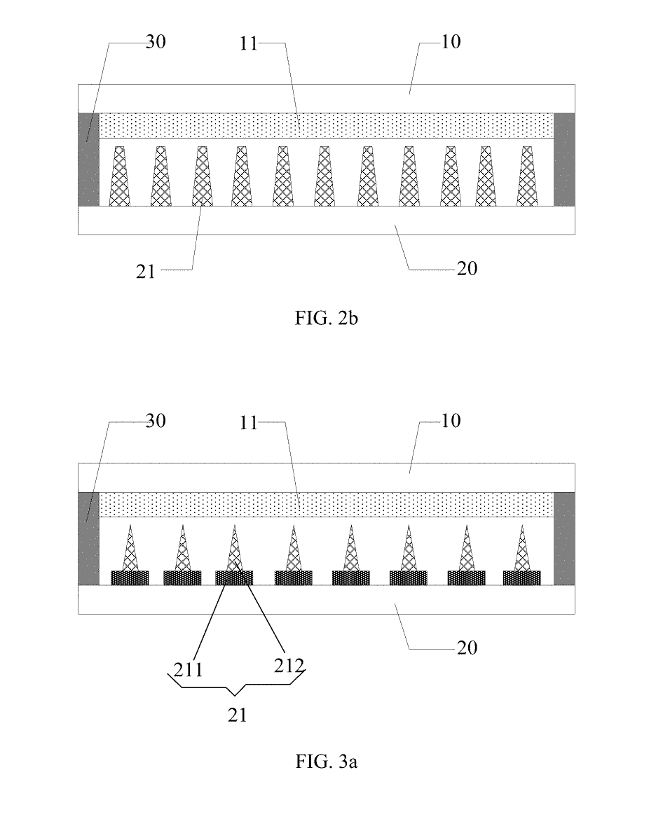

Referring to FIGS. 2a-2b, schematic diagrams of another exemplary pressure sensor are illustrated in accordance with some embodiments. As shown in FIGS. 2a-2b, the area of the cross section parallel with the second substrate 20 of each pressure sensing electrode 21 may decrease when the distance between the cross section and the second substrate 20 increases. That is, the pressure sensing electrodes 21 may have a shape such as a cone, a pyramid, or a frustum. The bottom of such structure may touch the second substrate 20 and the top of such structure may point away from the second substrate 20. Such structures may have an enlarged contact area between the bottom of pressure sensing electrodes 21 and the second substrate 20 to increase the adhesiveness. The tapered top of such structure may not only reduce the weight of the sensor but also increase the distance between adjacent pressure sensing electrodes 21 to minimize mutual interferences.

In one embodiment, as shown in FIG. 2a, the pressure sensor may have approximate cone-shaped or pyramid-shaped pressure sensing electrodes 21. In another embodiment, as shown in FIG. 2b, the pressure sensor may have approximate frustum-shaped pressure sensing electrodes 21.

Depending on specific designs, in embodiments of the present disclosure, the pressure sensing electrodes 21 may be approximate cone-shaped, pyramid-shaped, or frustum-shaped.

In one embodiment, in the pressure sensors described above, the pressure sensing electrodes 21 may be made of carbon nanotubes. The carbon nanotubes are chosen because the carbon nanotubes have superior conductivity and can be manufactured with a simple fabrication process. In addition, the pressure sensing electrodes 21 may be formed in the scale of micrometers by using the carbon nanotubes. In other embodiments, the pressure sensing electrodes 21 may be made of other appropriate conductive materials.

Further, in the pressure sensors described above, when the pressure sensing electrodes 21 are made of carbon nanotubes, the pressure sensing electrodes 21 may be formed by ink-jet printing using ink-jet printers.

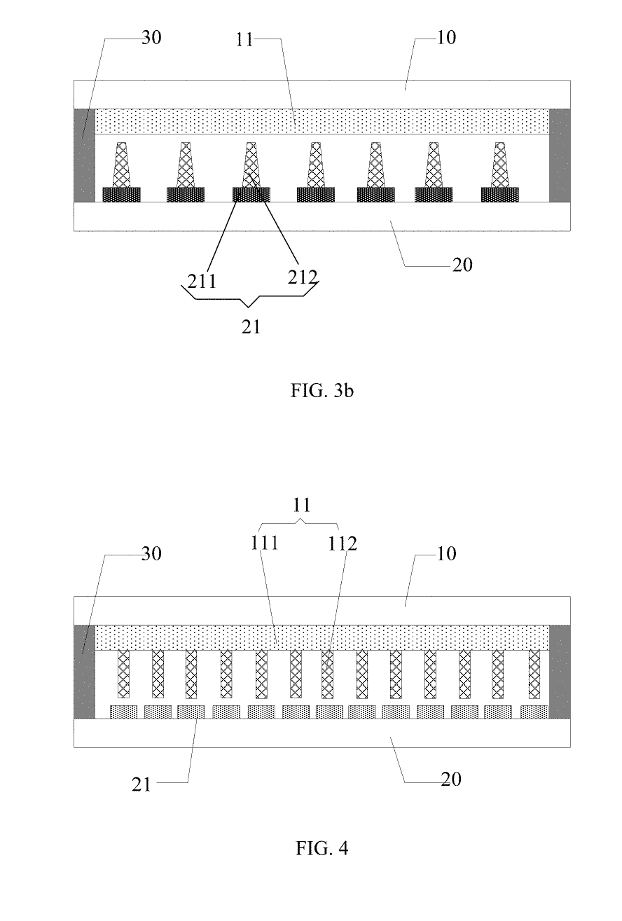

Referring to FIGS. 3a-3b, schematic diagrams of another exemplary pressure sensor are illustrated in accordance with some embodiments. As shown in FIGS. 3a-3b, each pressure sensing electrode 21 may include a first electrode 211 configured on one side of the second substrate 20 facing toward the first substrate 10, and a second electrode 212 configured on one side of the first electrode 211 facing toward the first substrate 10. The orthogonal projection of the first electrode 211 on the second substrate 20 may entirely cover the orthogonal projection of the second electrode 212 on the second substrate 20. The area of the cross section parallel with the second substrate 20 of the second electrode 212 may decrease when the distance between the cross section and the second substrate 20 increases.

In one embodiment, as shown in FIG. 3a, the second electrode 212 may have an approximate cone-shaped structure. In another embodiment, as shown in FIG. 3b, the second electrode 212 may have an approximate frustum-shaped structure.

Further, in one embodiment, in the pressure sensors described above, the first electrodes 211 may be made of metal, transparent conductive oxide, or other appropriate conductive materials.

Since the carbon nanotubes have a superior conductivity and a simple fabrication process, and the pressure sensing electrodes 21 may be formed in the scale of micrometers. In some embodiments, the second electrodes 212 may be made of carbon nanotubes.

Depending on specific designs, in the pressure sensors described above, when the second electrodes 212 are made of carbon nanotubes, the second electrodes 212 may be formed by ink-jet printing using ink-jet printers. Alternatively, the second electrodes 212 may be formed by growing nanotubes on the first electrodes 211.

Further, in the pressure sensors described above, the first electrodes 211 and the second electrodes 212 may be made of a same material or different materials.

In one embodiment, in the pressure sensors described above, the first electrodes 211 and the second electrodes may be made of a same material such that the first electrodes 211 and the second electrodes 212 may be formed in a single step of the patterning process.

Further, in the pressure sensors described above, as shown in FIGS. 1-3b, the common electrode 11 may have a plate structure. The pressure sensing circuit may only need one signal line to supply a voltage to the common electrode 11. Depending on specific designs, the common electrode 11 may be divided into a plurality of smaller plates. However, such structures may require more complicated masks in the patterning process, and may require more signal lines.

Depending on specific designs, in the pressure sensors described above, the common electrode 11 may be made of metal, transparent conductive oxide, or other appropriate conductive materials.

Referring to FIG. 4, a schematic diagram of another exemplary pressure sensor is illustrated in accordance with some embodiments. As shown in FIG. 4, the common electrode 11 may include a third electrode 111 configured on one side of the first substrate 10 facing toward the second substrate 20, and a plurality of fourth electrodes 112 configured on one side of the third electrode 111 facing toward the second substrate 20.

Each fourth electrode 112 may correspond to a pressure sensing electrode 21, respectively. The third electrode 111 may have a plate structure. Each fourth electrode 112 may have a columnar structure. When an external force is applied on the first substrate 10 and/or the second substrate 20, one or more pressure sensing electrodes 21 may contact their corresponding fourth electrodes 112.

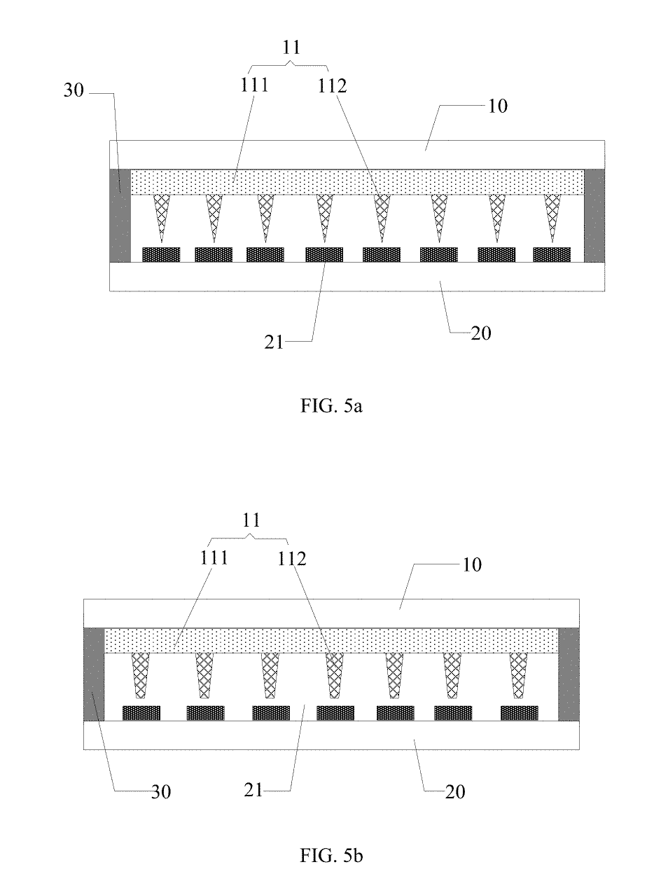

Referring to FIGS. 5a-5b, schematic views of another exemplary pressure sensor are illustrated in accordance with some embodiments. As shown in FIG. 5, the area of the cross section parallel with the first substrate 10 of each fourth electrode 112 may decrease when the distance between the cross section and the first substrate 10 increases. Such structure may have an enlarged contact area between the bottom of fourth electrodes 112 and the third electrode 111 to increase the adhesiveness. The tapered top of such structure may not only reduce the weight but also increase the distance between adjacent fourth electrodes 112 to minimize mutual interferences.

In one embodiment, as shown in FIG. 5a, each fourth electrode 112 may have an approximate cone-shaped structure. In another embodiment, as shown in FIG. 5b, each fourth electrode 112 may have an approximate frustum-shaped structure.

Depending on specific designs, each fourth electrode 112 may have an approximate cone-shaped structures, an approximate pyramid-shaped structure, or an approximate frustum-shaped structure.

Further, in the pressure sensors described above, the third electrode 111 and the fourth electrodes 112 may be made of a same material or different materials.

In one embodiment, in the pressure sensors described above, the third electrodes 111 and the fourth electrodes 112 may be made of a same material such that the third electrodes 111 and the fourth electrodes 112 may be formed in a single step of patterning process.

Further, in the pressure sensors described previously, as shown in FIGS. 4-5b, the third electrode 111 may be made of metal, transparent conductive oxide, or other appropriate conductive materials.

Since the carbon nanotubes have a superior conductivity and can be manufactured with a simple fabrication process, and the pressure sensing electrodes 21 may be formed in the scale of micrometers, the second electrodes 112 may be made of carbon nanotubes in one embodiment of the disclosed pressure sensors.

Depending on specific designs, in the pressure sensors described above, when the fourth electrodes 112 are made of carbon nanotubes, the fourth electrodes 112 may be formed by ink-jet printing using ink-jet printers. Alternatively, the fourth electrodes 112 may be formed by growing nanotubes on the third electrode 111.

Further, in the pressure sensors described previously, as shown in FIGS. 4-5b, each pressure sensing electrode 21 may have a block structure.

Depending on specific designs, in the pressure sensors described previously, the pressure sensing electrodes 21 may be made of metal, transparent conductive oxide, or other appropriate conductive materials.

Further, in one embodiment, at least one of the first substrate 10 and the second substrate 20 may be a flexible substrate.

In one embodiment, in the pressure sensors described above, the pressure sensing electrodes 21 may be configured on the second substrate 20 in an array arrangement.

Specifically, in the pressure sensors described above, when the pressure sensing electrodes are arranged in an array, the pressure sensing circuit may retrieve the voltages of the pressure sensing electrodes row by row. The analog signals of the retrieved voltages may be fed into a microcontroller through a general purpose input output (GPIO) interface. The microcontroller may convert the analog voltage signals into digital signals (0s and 1s) and store the digital signals in a memory. The digital signals stored in the memory may be used to determine the touching position where an external force is applied.

Depending on specific designs, because a duration time of an applied external force and a recovering time of a deformed pressure sensing electrodes are usually around one second, the sampling frequency may be at least 10000 samples per second to accommodate the processing and storing of the voltage information from all pressure sensing electrodes.

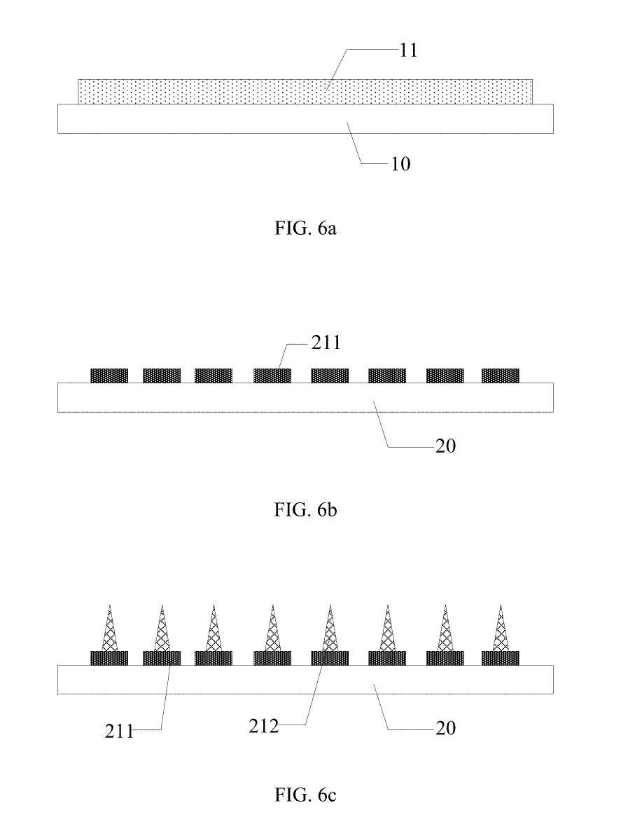

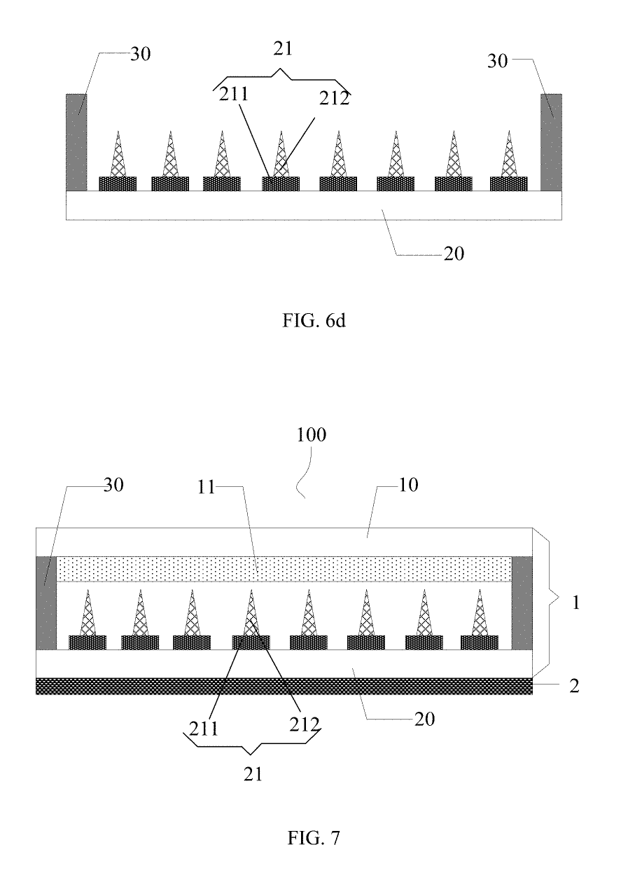

Another aspect of the disclosed subject matter provides a method for fabricating the disclosed pressure sensors. Referring to FIGS. 6a-6d, certain fabrication steps for an exemplary pressure sensor are illustrated in accordance with some embodiments of the present disclosure.

Referring to FIG. 9, a flow chart of an exemplary method for fabricating a pressure sensor is illustrated in accordance with some embodiments. As shown in FIG. 9, the fabrication method may include the following steps.

Step S10: providing a first substrate and forming a common electrode on the first substrate.

Specifically, as shown in FIG. 6a, a first substrate 10 is provided. A common electrode 11 may be formed on the first substrate 10 by a patterning process. In one embodiment, the common electrode 11 may be made of indium tin oxide (ITO), copper (Cu), etc.

Step S11: providing a second substrate and forming a plurality of first electrodes on the second substrate.

Specifically, as shown in FIG. 6b, a second substrate 20 is provided. A plurality of first electrodes 211 may be formed on the second substrate 10 by using a patterning process. In one embodiment, the first electrodes 211 may be made of indium tin oxide (ITO). The first electrodes 211 may also be called compensating electrodes.

Step S12: forming multiple second electrodes on the first electrodes.

Specifically, as shown in FIG. 6c, a second electrode 212 may be formed on each first electrode 211. In one embodiment, the first electrodes 211 and the second electrodes 212 may be made of carbon nanotubes. The first electrodes 211 and the second electrodes 212 may be formed by ink-jet printing using ink-jet printers or by a surface growing process.

Step S13: forming a sealant frame on the second substrate.

Specifically, as shown in FIG. 6d, a sealant frame 30 may be formed on the second substrate 20. The first electrodes 211 and the second electrodes 212 together may form the pressure sensing electrodes 21.

Step S14: bonding the first substrate and the second substrate together by the sealant frame and curing the sealant frame with an ultra violet light to form a pressure sensor.

Specifically, the first substrate 10 and the second substrate 20 may be bonded together by the sealant frame 30. Then, the sealant frame 30 may be cured by an ultra violet light. Thus, a pressure sensor as shown in FIG. 3a may be formed.

In other embodiments, similar fabrication methods may be used to form the pressure sensors described above because such pressure sensors have similar structures.

Another aspect of the disclosed subject matter provides a haptic feedback device. Referring to FIG. 7, a schematic diagram of an exemplary haptic feedback device is illustrated in accordance with some embodiments. As shown in FIG. 7, the haptic feedback device 100 may include a haptic feedback circuit 2 and a pressure sensor 1. The haptic feedback circuit 2 may be configured on one side of the first substrate 10 facing away from the second substrate 20. Alternatively, the haptic feedback circuit 2 may be configured on one side of the second substrate 20 facing away from the first substrate 10.

The haptic feedback circuit 2 may be used to receive instructions from a terminal to make the haptic feedback circuit 2 apply voltage pulses stimuli to object contacting the haptic feedback device. The pressure sensor 1 may also be used to send the detected position information to the terminal. A terminal may be a computing device with virtual reality functions. For example, a terminal may be a computer, a smartphone, a smart TV, etc.

The terminal may use the pressure sensor to determine the positions of human body contacts and may use the haptic feedback circuit to produce voltage pulses to stimulate the human body. Thus, a human-machine interaction may be achieved.

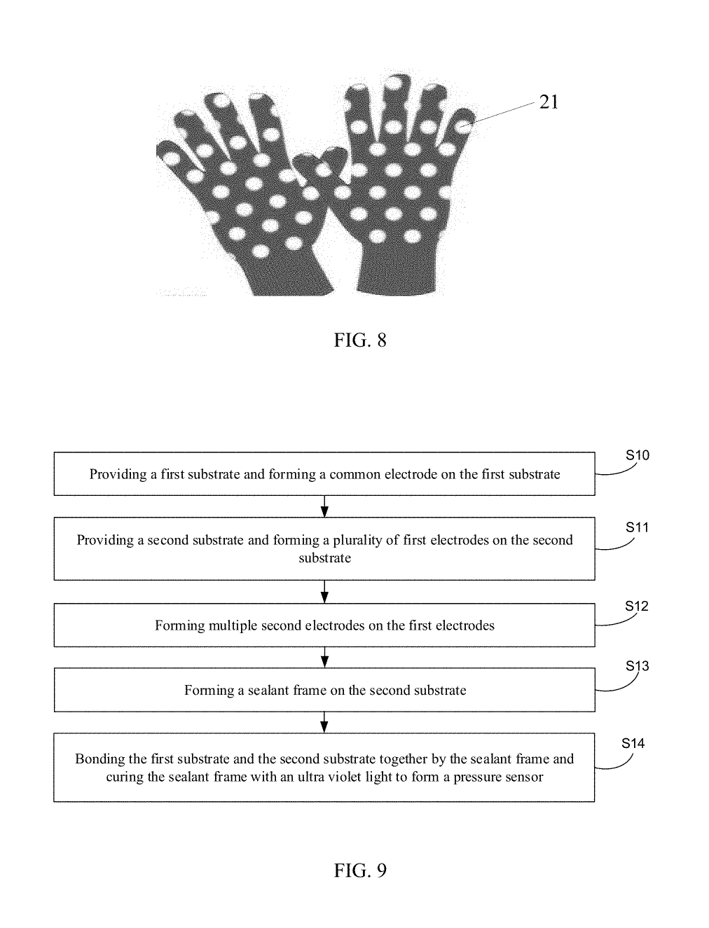

Another aspect of the disclosed subject matter provides a glove that can be used in a virtual reality system. Referring to FIG. 8, a diagram of an exemplary glove is illustrated in accordance with some embodiments. As shown in FIG. 8, at least the palm side of the glove may include the haptic feedback device in some embodiments. Only the pressure sensing electrodes 21 maybe shown in FIG. 8.

In one embodiment, the first substrate and the second substrate of the pressure sensor in the haptic feedback device may be flexible substrates. The haptic feedback circuit may also be flexible circuit and may be disposed on the inner side of the glove.

Specifically, when a user clenches fists or takes another action, the pressure sensor may be actuated by the first pressure, and certain pressure sensing electrodes and the common electrode may contact with one another. When the pressure sensing circuit detects voltages from the pressure sensing electrodes corresponding to all five fingers and the palm, it indicates that the user wearing the glove may clench the fist. When the pressure sensing circuit detects voltages from the pressure sensing electrodes corresponding to the joint of index finger, it indicates that the user wearing the glove may bend the index finger. Thus, such glove may determine hand movements.

On the other hand, placing the haptic feedback circuit on the inner side of the glove may enable the haptic feedback circuit to produce voltage pulses to stimulate human skin based on the instructions from the terminal. Thus, a human-machine interaction may be achieved.

Further, depending on specific designs, the pressure sensing circuit may also be configured in a position of the glove close to the wrist or on the back of the hand.

Another aspect of the disclosed subject matter provides a helmet that can be used in a virtual reality system. For example, a helmet may include a disclosed haptic feedback device in some embodiments.

In one embodiment, the first substrate and the second substrate of the pressure sensor in the haptic feedback device may be flexible substrates. The haptic feedback circuit may be flexible circuit. The haptic feedback circuit may be configured on the inner side of the helmet. The helmet may operate in a similar way as the glove.

Another aspect of the disclosed subject matter provides a virtual reality system. The virtual reality system may include a terminal, a glove according to the present disclosure, and/or a helmet according to the present disclosure.

Further, in one embodiment, the terminal may be used to send instructions to the flexible haptic feedback circuit in the haptic feedback device. The flexible haptic feedback circuit may produce voltage pulses to stimulate the human body based on the instructions from the terminal. The terminal may determine human body movements based on the position information collected by the pressure sensor in the haptic feedback device. Thus, a human-machine interaction may be achieved.

Accordingly, the disclosed subject matter provides a pressure sensor, a haptic feedback device, and related devices. The pressure sensor may include a first substrate, a second substrate, a sealant frame, a common electrode, a plurality of pressure sensing electrodes, and a pressure sensing circuit. The sealant frame bonds the edges of the first substrate and the second substrate and supports the separation between the first substrate and the second substrate inside the sealant frame so that the pressure sensing electrodes and the common electrode may be insulated from one another when no external force is applied.

The pressure sensing electrodes and the common electrode may contact one another only when an external force is applied to the first substrate and/or the second substrate. Voltages may be applied on the pressure sensing electrodes only when an external force is applied to the substrates. Thus, the pressure sensing circuit may determine the position where the external force is applied by measuring the voltages on the pressure sensing electrodes. Thus, a simple pressure sensor may be realized.

Various embodiments have been described to illustrate the operation principles and exemplary implementations. The embodiments disclosed herein are exemplary only. Other applications, advantages, alternations, modifications, or equivalents to the disclosed embodiments are obvious to those skilled in the art and are intended to be encompassed within the scope of the present disclosure.

The labels used in the figures may include the following:
10—first substrate;
11—common electrode;
111—third electrode;
112—fourth electrode;
20—second substrate;
21—pressure sensing electrode;
211—first electrode;
212—second electrode;
30—sealant frame; and
100—haptic feedback device.

1-20. (canceled)

21. A pressure sensor, comprising:
a first substrate;
a second substrate facing toward the first substrate;
a sealant frame for bonding the edges of the first substrate and the second substrate and for supporting a separation between the first substrate and the second substrate inside the sealant frame;
a common electrode on one side of the first substrate inside the sealant frame and facing toward the second substrate;
a plurality of pressure sensing electrodes on one side of the second substrate inside the sealant frame and facing toward the first substrate, wherein the plurality of pressure sensing electrodes are independent from each other, and when an external force applied to a position on at least one of the first substrate and the second substrate exceeds a certain threshold, at least one pressure sensing electrode corresponding to the position contacts the common electrode; and
a pressure sensing circuit supplying pressure sensing signals to the common electrode, and determining a position where an external force is applied by measuring at least one voltage on the pressure sensing electrodes.

22. The pressure sensor of claim 21, wherein:
an area of an orthogonal projection of each pressure sensing electrode on a plane parallel to the second substrate inversely correlates with a distance between the plane and the second substrate.

23. The pressure sensor of claim 22, wherein:
each pressure sensing electrode has a cone-shaped structure, a pyramid-shaped structure, or a frustum-shaped structure.

24. The pressure sensor of claim 22, wherein:
the pressure sensing electrodes are made of carbon nanotubes.

25. The pressure sensor of claim 21, wherein:
each pressure sensing electrode includes a first electrode on one side of the second substrate facing toward the first substrate, and a second electrode on one side of the first electrode facing toward the first substrate;
an orthogonal projection of the first electrode on the second substrate covers entirely an orthogonal projection of the second electrode on the second substrate; and
an area of an orthogonal projection of each second electrode on a plane parallel to the second substrate inversely correlates with a distance between the plane and the second substrate.

26. The pressure sensor of claim 25, wherein:
each second electrode is a cone-shaped structure, a pyramid-shaped structures, or a frustum-shaped structure.

27. The pressure sensor of claim 25, wherein:
the second electrodes are made of carbon nanotubes.

28. The pressure sensor of claim 21, wherein:
the common electrode includes a third electrode on one side of the first substrate facing toward the second substrate, and a plurality of fourth electrodes on one side of the third electrode facing toward the second substrate;
the third electrode has a plate-shaped structure; and
an area of an orthogonal projection of each fourth electrode on a place parallel with the first substrate inversely correlates with a distance between the plane and the first substrate.

29. The pressure sensor of claim 28, wherein:
each fourth electrode has a cone-shaped structure, a pyramid-shaped structure, or a frustum-shaped structure.

30. The pressure sensor of claim 28, wherein:
the fourth electrodes are made of carbon nanotubes.

31. The pressure sensor of claim 21, wherein:
at least one of the first substrate and the second substrate is a flexible substrate.

32. A haptic feedback device, comprising:
a haptic feedback circuit either on one side of the first substrate facing away from the second substrate, or on one side of the second substrate facing away from the first substrate; and
a pressure sensor according to claim 21 used for determining at least one touch position, and for sending touch position information to a terminal;
wherein the haptic feedback circuit produces voltage pulses based on instructions from the terminal.

33. A glove used for a virtual reality system, wherein:
at least a palm side of the glove includes a haptic feedback device according to claim 32;
the first substrate and the second substrate of the pressure sensor in the haptic feedback device are flexible substrates; and
the haptic feedback circuit is a flexible circuit, and is on an inner side of the glove.

34. A helmet used for a virtual reality system, comprising:
a haptic feedback device according to claim 32 on an inner side of the helmet;
wherein the first substrate and the second substrate of the pressure sensor in the haptic feedback device are flexible substrates, and the haptic feedback circuit is a flexible circuit.

35. A virtual reality system, comprising:
a terminal; and
a helmet according to claim 34.

36. A method for fabricating a pressure sensor, comprising:
providing a first substrate and forming a common electrode on the first substrate;
providing a second substrate and forming a plurality of first electrodes on the second substrate;
forming a plurality of second electrodes on the first electrodes;
forming a sealant frame on the second substrate; and
bonding the first substrate and the second substrate together by the sealant frame and curing the sealant frame with an ultra violet light.

37. The method of claim 36, wherein:
the plurality of first electrodes and the plurality of second electrodes are made of a same material; and
the plurality of first electrodes and the plurality of second electrodes are formed in a single patterning process.

38. The method of claim 36, wherein:
the plurality of first electrodes and the plurality of second electrodes are made of carbon nanotubes; and
the plurality of first electrodes and the plurality of second electrodes are formed by an ink-jet printing process, or by a surface growing process.

39. The method of claim 36, wherein:
each second electrode is a cone-shaped structure, a pyramid-shaped structure, or a frustum-shaped structure.

40. The method of claim 36, wherein forming the common electrode comprising:
forming a third electrode on one side of the first substrate facing toward the second substrate, wherein the third electrode has a plate-shaped structure; and
forming a plurality of fourth electrodes on one side of the third electrode facing toward the second substrate;
wherein each fourth electrode is a cone-shaped structure, a pyramid-shaped structure, or a frustum-shaped structure.
